(19) United States
(12) Patent Application Publication
(10) Pub. No.: US 2008/0070452 A1
(43) Pub. Date: Mar. 20, 2008

(54) Female Contact

(76) Inventors: Ryuichi Komiyama, Tokyo (JP); Kazushige Sakamaki, Tokyo (JP)

Correspondence Address: BARLEY SNYDER, LLC, 1000 WESTLAKES DRIVE, SUITE 275, BERWYN, PA, 19312, US

(21) Appl. No.: 11/937,221

(22) Filed: Nov. 8, 2007

(30) Foreign Application Priority Data
Aug. 11, 2006 (JP) 2006-303183

(51) Int. Cl. H01R 13/11

(52) U.S. Cl. 439/852

(57) ABSTRACT

A female contact according to the invention can avoid the impact of the tip end surface of a mating male contact such as a tab or pin with the contact section of an resilient contact member. The female contact comprises an resilient contact member having a contact section that makes contact with a mating male contact. The resilient contact member is provided with a projection that causes the contact section to be displaced from the initial position before the tip end surface of the male contact contacts the contact section.

### CROSS-REFERENCE TO RELATED APPLICATION DATA

This application claims the benefit of the earlier filed parent Japanese Patent Application JP 2006-303183 having a filing date of Nov. 8, 2006.

### FIELD OF THE INVENTION

The present invention relates to a female contact having a resilient contact member having a contact section that contacts a mating male contact such as a tab or pin.

### BACKGROUND

The female contact shown in FIGS. 9 and 10 (see JP2004-362832A) is a conventional female contact. FIG. 9 is a sectional view in which one portion of a conventional female contact is cut. FIG. 10 is a partial sectional view at an intermediate point during the insertion of a mating male contact into an electrical connector comprising the female contact shown in FIGS. 9 and 10.

The female contact 100 shown in FIG. 9 comprises a receptacle 101 and an electrical wire terminal section 110, and is formed by stamping and forming metal.

As is shown in FIG. 10, the receptacle 101 is constructed in a substantially box shape so as to receive a tab T provided on a mating connector (not shown in the figures), and comprises a base plate 102 extending in the forward-rearward direction (left-right direction in FIG. 10), a pair of side walls 103 rising from either side edge of the base plate 102 in the direction of width (direction perpendicular to the plane of page in FIG. 10), and a pair of top plates 104 respectively bent from the pair of side walls 103 so as to overlap above and below.

A resilient contact member 105 extends rearward at an upward angle in a cantilever form from the front edge of the base plate 102 via a bent section 105a. The resilient contact member 105 is formed with a thickness that is smaller than the other parts constituting the female contact 100 by cutting off the entire undersurface of the resilient contact member 105 that faces the base plate 102. A contact section 105b which is contacted by the tab T that is inserted into the receptacle 101, and which is formed out upward in the shape of a step is provided toward the rear of the resilient contact member 105. This contact section 105b takes on an anterior inclined slope shape when the resilient contact member 105 is in a free state, but is displaced to a nearly horizontal angle (parallel to the direction of insertion of the tab T) in a state in which the tab T is fully inserted. This contact section 105b is formed over the entire width of the resilient contact member 105.

Furthermore, a resilient receiving leg 106 is formed substantially in the central portion of the base plate 102 in the forward-rearward direction by cutting a portion of the base plate 102 and raising this portion upward. The resilient receiving leg 106 extends forward at an upward inclination in a cantilever form, and is designed to undergo downward resilient deformation with its rear end as the fulcrum. The front end of the resilient receiving leg 106 is designed to support the rear end of the resilient contact member 105 from below when the resilient contact member 105 flexes downward. Moreover, a projection 107 for restricting excessive flexing is formed on the base plate 102 in a position in front of the resilient receiving leg 106.

In addition, a receiving wall 104a that is formed parallel to the normal insertion direction of the tab T by protruding downward is formed on the lower-side top plate 104 out of the pair of top plates 104.

Furthermore, as is shown in FIG. 9, the electrical wire terminal section 110 comprises a wire crimp member 111 that extends from the rear end of the base plate 102 and that crimps the core wire of an electrical wire W, and an insulation crimp member 112 that extends from the rear end of the wire crimp member 111 and that crimps the insulation of the electrical wire W.

Moreover, as is shown in FIG. 10, the female contact 100 constructed as described above is received inside the contact receiving cavity 121 formed in the housing 120, and is locked by a housing lance 123.

As is shown in FIG. 10, the tab T provided on the mating connector comprises a tip end surface Ta that extends in a direction perpendicular to the direction of insertion of the tab T at the tip end, and a pair of upper and lower angled surfaces Tb formed as a taper. Furthermore, this tab T is inserted into the contact receiving cavity 121 from the tab insertion hole 122 that communicates with the contact receiving cavity 121 in the housing 120, and is inserted into the receptacle 101 of the female contact 100. As a result, the tab T and the contact section 105b of the resilient contact member 105 make contact with each other, so that the tab T and electrical wire W are electrically connected.

Here, because the thickness of the resilient contact member 105 is smaller than the thicknesses of the other parts making up the female contact 100, not only in cases where the tab T is inserted into the female contact 100 in the normal direction (horizontal direction), but also in cases where the tab T is inserted into the female contact 100 at a downward angle, the frictional resistance between the tab T and the resilient contact member 105 is reduced. In addition, even with the thickness of the resilient contact member 105 being reduced, the front end of the resilient support member 106 is designed to support the rear end of the resilient contact member 105 from below when the resilient contact member 105 flexes downward. Therefore, there is no lowering of the contact pressure of the tab T and the resilient contact member 105 in a state in which the insertion of the tab T has been completed.

Incidentally, there are cases in which the conventional female contact 100 shown in FIGS. 9 and 10 is used in a connector for automotive use, for example. In the field of automotive connectors, small-sized connectors have been developed in which the width of the tab T constituting the mating male contact is 1.0 mm or less, for instance, and along with this development, smaller size contacts such as the female contact 100 itself have also been in development. In cases where the female contact 100 is made smaller, in order to have a large amount of displacement of the resilient contact member 105, it is necessary to reduce the size of the contact gap into which the tab T is inserted (space between the receiving part 104a of the top plate 104 and the contact section 105b of the resilient contact member 105).

On the other hand, for manufacturing reasons, the tab T always has the tip end surface Ta, which cannot be eliminated. Here, if the contact gap into which the tab T is inserted is made smaller in a female contact 100, there is a danger that the edge portion of the tip end surface Ta will impact the contact surface of the contact section 105b, and scratch the contact surface during the insertion of the tab T. When the contact surface of the contact section 105b is scratched, the surface plated with tin, gold, or the like that is applied to the contact surface is damaged, so that the contact resistance is increased, creating the risk of failure in electrical connection.

### SUMMARY

Accordingly, it is an object of the present invention, among other objects, to provide a small-sized female contact which can avoid the tip end surface of the mating male contact such as a tab or pin from impacting the contact section of the resilient contact member.

The female contact of the invention has a resilient contact member having a contact section that contacts a mating male contact, wherein the resilient contact member is provided with a projection that causes the contact section to be displaced from the initial position before the tip end surface of the male contact comes into contact with the contact section.

### BRIEF DESCRIPTION OF THE DRAWINGS

The invention will now be described by way of example with reference to the drawings of which:

FIG. 1 is a perspective view of a first exemplary embodiment of the inventive female contact connected to a contact carrier;

FIGS. 2A and 2B show the female contact of FIG. 1, with FIG. 2A being a longitudinal sectional view, and FIG. 2B being a sectional view along line 2B-2B in FIG. 2A;

FIG. 3 is a longitudinal sectional view at an intermediate point during the insertion of a mating male contact into the receptacle of the female contact;

FIG. 4 is an explanatory diagram at an intermediate point during the insertion of the male contact into the female contact shown in FIGS. 1 through 3 from which the projection has been removed;

FIG. 5 is an explanatory diagram at an intermediate point during the insertion of the male contact into the female contact shown in FIGS. 1 through 3;

FIG. 6 is an explanatory diagram of a state in which the insertion of the male contact has progressed from the state shown in FIG. 5;

FIG. 7 is an explanatory diagram of a state in which the insertion of the male contact has been completed; in FIG. 7, the constituent elements of the female contact other than the resilient contact member and receiving part are omitted;

FIGS. 8A and 8B show the resilient contact member of a second embodiment of the female contact of the present invention, with FIG. 8A being a partial perspective view, and FIG. 8B being a sectional view along line 8B-8B in FIG. 8A;

FIG. 9 is a sectional view in which one portion of a conventional female contact is cut; and

FIG. 10 is a partial sectional view at an intermediate point during the insertion of a mating male contact into an electrical connector comprising the female contact shown in FIG. 9.

### DESCRIPTION OF THE EMBODIMENTS

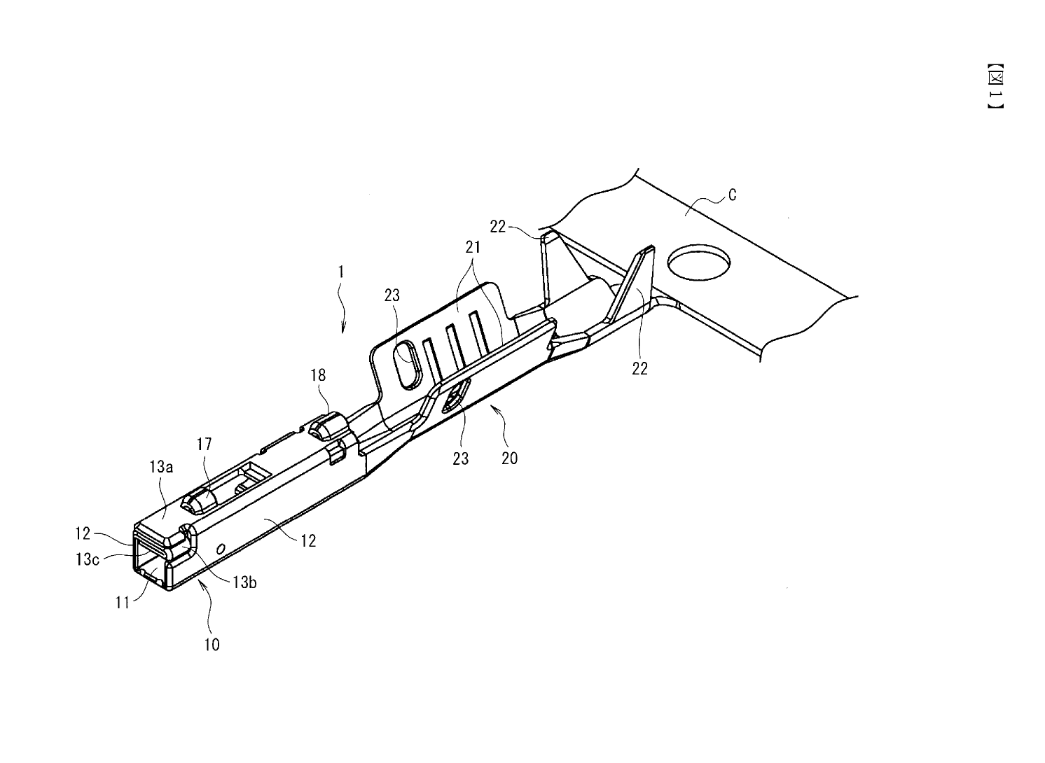

Next, embodiments of the present invention will be described with reference to the figures. In FIG. 1, the female contact 1 comprises a receptacle 10 and a terminal section 20, and is formed by stamping and forming metal. Although the female contact 1 is connected to a contact carrier C in FIG. 1, the female contact 1 is designed to be cut off from the contact carrier C following stamping and forming operations.

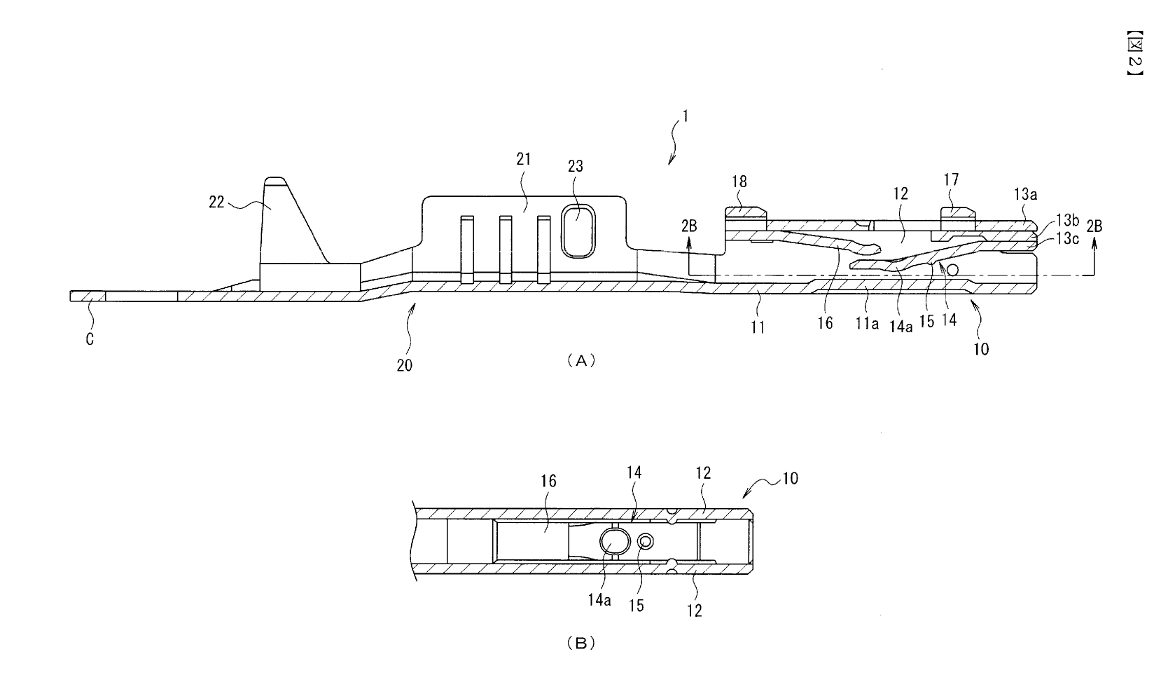

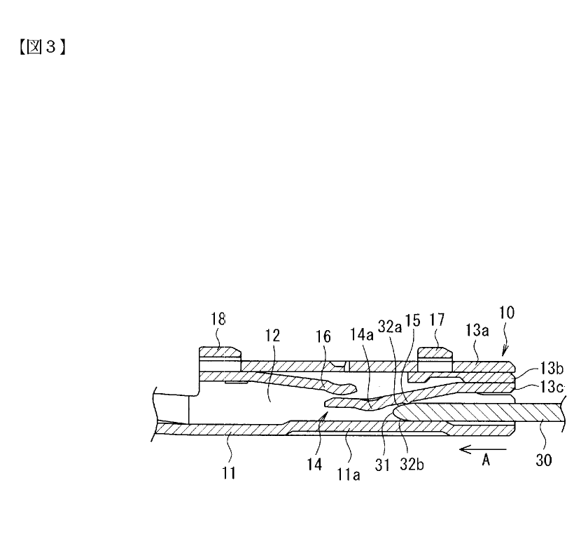

As is shown in FIGS. 1, 2A and 2B, the receptacle 10 is formed in a substantially box shape so as to receive a male contact 30 (see FIG. 3) provided on a mating connector (not shown in the figures). The receptacle 10 comprises a base plate 11 extending in the forward-rearward direction, a pair of side walls 12 rising from either edge portion of the base plate 11 in the direction of width (vertical direction in FIG. 2B), and an upper-side first top plate 13a and a lower-side second top plate 13b that are respectively bent from the pair of side walls 12 so as to overlap above and below. Here, the right side in FIG. 2A is referred to as the front side, and the left side is referred to as the rear side.

As is shown in FIG. 3, the male contact 30 is formed in a tab shape, and has at the tip end thereof a tip end surface 31 that is perpendicular to the direction of insertion of the male contact 30 indicated by arrow A, and an upper angled surface 32a and a lower angled surface 32b that are formed so that the thickness of the male contact 30 becomes gradually smaller toward the tip end surface 31. The upper angled surface 32a extends rearward at a downward angle from the upper surface of the male contact 30 toward the tip end surface 31, the side toward the tip end surface 31 in the male contact 30 being referred to as the rear side, while the lower angled surface 32b extends rearward at an upward angle from the undersurface of the male contact 30 toward the tip end surface 31. As is shown in FIG. 3, the male contact 30 is designed to be inserted into the receptacle 10 from the front side of the receptacle 10 toward the rear, i.e., in the direction indicated by arrow A. In the present embodiment, the male contact 30 is formed with a width of 1.0 mm or less, and the receptacle 10 is also formed with a minimum width required for receiving the male contact 30.

Furthermore, a receiving part 1 la that is parallel to the normal insertion direction of the male contact 30 is formed on the base plate 11 by protruding upward.

Moreover, a primary locking projection 17 for performing the primary locking of the female contact 1 with the housing (not shown in the figures) is formed so as to protrude from an area toward the front of the upper-side first top plate 13a, and a secondary locking projection 18 for performing the secondary locking of the female contact 1 with the housing is formed so as to protrude from the rear end portion of the upper-side top plate 13a.

In addition, as is shown in FIG. 1, one side edge of the front end portion of the lower-side second top plate 13b is formed in a double configuration by being folded back underneath the second top plate 13b, thus forming a third top plate 13c. As is shown in FIG. 2A, an resilient contact member 14 extends rearward at a downward angle in a cantilever manner from the rear end portion of the third top plate 13c. A contact section 14a which is contacted by the male contact 30 that is inserted into the receptacle 10 is provided toward the rear of the resilient contact member 14. As is shown in FIG. 2B, this contact section 14a is formed as a dimple by striking downward upon substantially the central portion in the direction of width of the resilient contact member 14. Plating such as tin or gold plating is applied to the contact surface of the contact section 14a. The resilient contact member 14 is designed to flex upward with the front end portion as the fulcrum from the free state shown in FIG. 2A in which the contact section 14a is closest to the receiving part 11a formed on the base plate 11.

Furthermore, as is shown in FIGS. 2A, 2B and 3, a projection 15 that causes upward displacement of the contact section 14a from the initial position (position of the contact section 14a when the resilient contact member 14 is in the free state) before the tip end surface 31 of the male contact 30 contacts the contact section 14a is provided on the resilient contact member 14 on the front side of the contact section 14a, i.e., toward the front in the direction of insertion of the male contact 30. This projection 15 is constructed by stamping substantially in the central portion of the resilient contact member 14 as shown in FIG. 2B. Moreover, the height of the projection 15 is set so that this projection 15 does not contact the male contact 30 in a state in which the insertion of the male contact 30 has been completed, and the male contact 30 has made contact with the contact section 14a (see FIG. 7). Further details on use of the projection 15 will be described later.

In addition, a resilient support member 16 is formed in the area toward the rear of the second top plate 13b as shown in FIG. 2A. This resilient support member 16 extends forward at a downward angle in a cantilever fashion and is designed to flex upward with the rear end as the fulcrum. The front end of the resilient support member 16 is designed to support the rear end of the resilient contact member 14 from above when the resilient contact member 14 flexes upward.

Meanwhile, as is shown in FIG. 1, the terminal section 20 comprises a pair of wire crimp members 21 rising from either side edge of the rear end of the base plate 11 and crimping the core wire of an electrical wire (not shown in the figures), and a pair of insulation crimp members 22 respectively provided on the rear side of the wire crimp members 21 and crimping the covering part of the electrical wire. A core wire position confirmation hole 23 for confirming the position of the core wire is formed in each of the wire crimp members 21.

Furthermore, the female contact 1 constructed in this manner is insertable into the contact receiving cavity of an electrical connector housing (not shown in the figures).

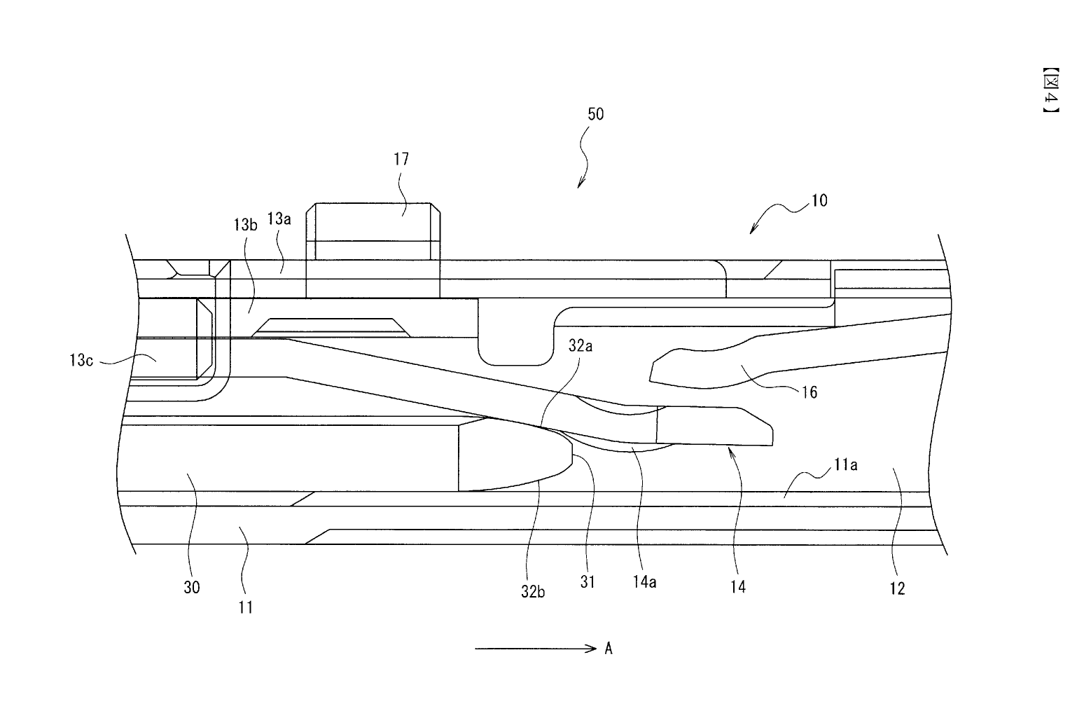

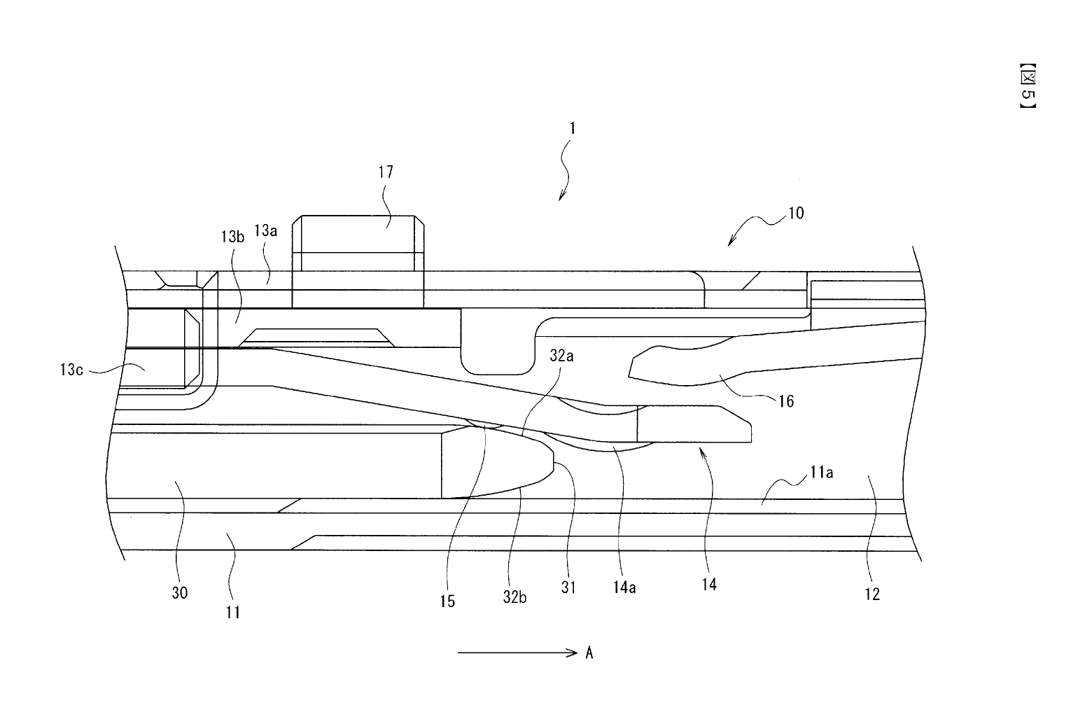

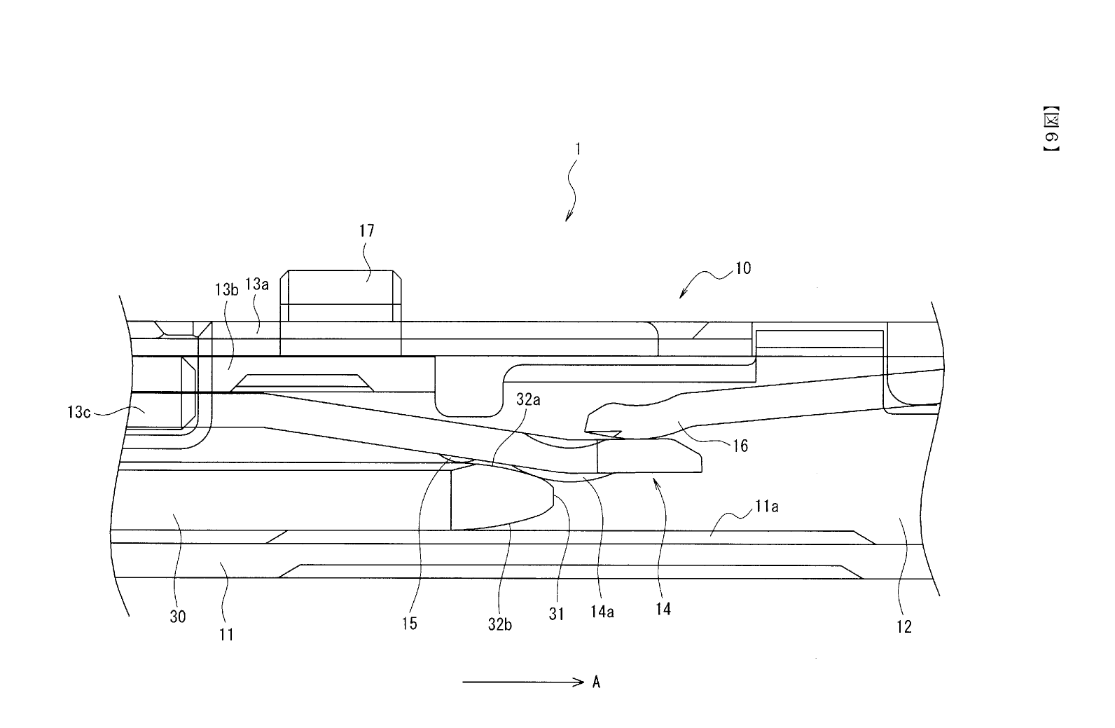

Next, use of the projection 15 provided on the resilient contact member 14 will be described in detail with reference to FIGS. 4 through 7. FIG. 4 is an explanatory diagram at an intermediate point during the insertion of the male contact 30 into the female contact 1 shown in FIGS. 1 through 3 from which the projection has been removed. FIG. 5 is an explanatory diagram at an intermediate point during the insertion of the male contact 30 into the female contact 1 shown in FIGS. 1 through 3. FIG. 6 is an explanatory diagram of a state in which the insertion of the male contact has progressed from the state shown in FIG. 5. FIG. 7 is an explanatory diagram of a state in which the insertion of the male contact has been completed; in FIG. 7, the constituent elements of the female contact other than the resilient contact member and receiving part are omitted.

As is shown in FIG. 4, if the male contact 30 is inserted into the receptacle 10 of a female contact 50 that is not provided with anything corresponding to the projection 15 on the resilient contact member 14, the male contact 30 advances inward while the undersurface of the male contact 30 in the vicinity of the tip moves along over the surface of the receiving part 11a. Then, the upper angled surface 32a at the tip of the male contact 30 advances along over the undersurface of the resilient contact member 14, and the upper edge portion of the tip end surface 31 of the male contact 30 contacts the contact surface of the contact section 14a that is formed by swaging. As a result, the contact surface of the contact section 14a is scratched, so that the plated surface applied on the contact surface becomes rough, resulting in an increase in contact resistance, which leads to a failure in electrical connection.

In contrast, in the case of the female contact 1 shown in FIGS. 1 through 3, when the male contact 30 is inserted into the receptacle 10 as shown in FIG. 5, the male contact 30 advances inward (direction indicated by arrow A in FIG. 5) with the undersurface in the vicinity of the tip of the male contact 30 moving along over the surface of the receiving part 1 la. Then, the upper angled surface 32a contacts the projection 15 before the tip end surface 31 of the male contact 30 contacts the contact section 14a, so that the projection 15 climbs over the upper angled surface 32a. As a result, the contact section 14a of the resilient contact member 14 is displaced upward from the initial position.

Then, when the insertion of the male contact 30 has progressed in the direction indicated by arrow A from the state shown in FIG. 5, the tip of the male contact 30 further advances while the undersurface of the male contact 30 moves along over the surface of the receiving part 11a, and the contact section 14a climbs over the upper angled surface 32a as shown in FIG. 6. In this state, the projection 15 climbs over the boundary between the upper surface of the male contact 30 and the upper angled surface 32a. During the process of the contact section 14a climbing over the upper angled surface 32a, the contact section 14a is displaced upward from the initial position. Therefore, even in cases where the contact gap between the contact section 14a and the receiving part 1 la in the initial position is even smaller than in the prior art, the contact section 14a and the upper angled surface 32a come into contact at a shallow angle close to 180°, so that the impact of the edge portion of the tip end surface 31 of the male contact 30 formed in a tab shape with the contact section 14a is reliably avoided. Because the contact section 14a and the upper angled surface 32a contact at a shallow angle close to 180°, there is no scratching on the contact surface of the contact section 14a or the surface roughness of the plated surface applied to the contact surface, so that this type of failure in the electrical connection between the male contact 30 and female contact 1 is avoided. The height and installation location in the forward-rearward direction of the projection 15 are adjusted so that the contact section 14a and the upper angled surface 32a contact at a shallow angle close to 180° during the process of the contact section 14a climbing over the upper angled surface 32a. Furthermore, when the contact section 14a climbs over the upper angled surface 32a, the resilient contact member 14 is further displaced upward, and the front end (left end in FIG. 6) of the resilient support member 16 supports the rear end of the resilient contact member 14 from above as shown in FIG. 6, so that the resilient support member 16 imparts in a supplementary manner a normal force that is sufficient for achieving the electrical connection to the resilient contact member 14.

Moreover, when the insertion of the male contact 30 has progressed in the direction indicated by arrow A from the state shown in FIG. 6, and the insertion is completed, the tip of the male contact 30 further advances with the undersurface of the male contact 30 moving along over the surface of the receiving part 11a, and the contact section 14a climbs over the upper surface of the male contact 30 as shown in FIG. 7. This completes the electrical connection between the male contact 30 and the electrical wire that is connected to the female contact 1. The height of the projection 15 is set so that this projection 15 does not contact the male contact 30 in a state in which the insertion of the male contact 30 has been completed, and the male contact 30 has made contact with the contact section 14a. Therefore, in a state in which the contact section 14a has climbed over the upper surface of the male contact 30, this projection 15 does not contact the male contact 30. Consequently, the projection 15 is made possible not to have any effect on the contact stability between the male contact 30 and the contact section 14a. Moreover, when the contact section 14a climbs over the upper surface of the male contact 30, the resilient contact member 14 is further displaced upward, so that the resilient force imparted to the resilient contact member 14 from the resilient support member 16 is increased. As a result, the contact pressure of the contact section 14a against the male contact 30 is increased. Furthermore, because the projection 15 is a swaged part that is provided substantially in the central portion of the resilient contact member 14, this projection can be formed easily by stamping substantially the central portion of the resilient contact member 14.

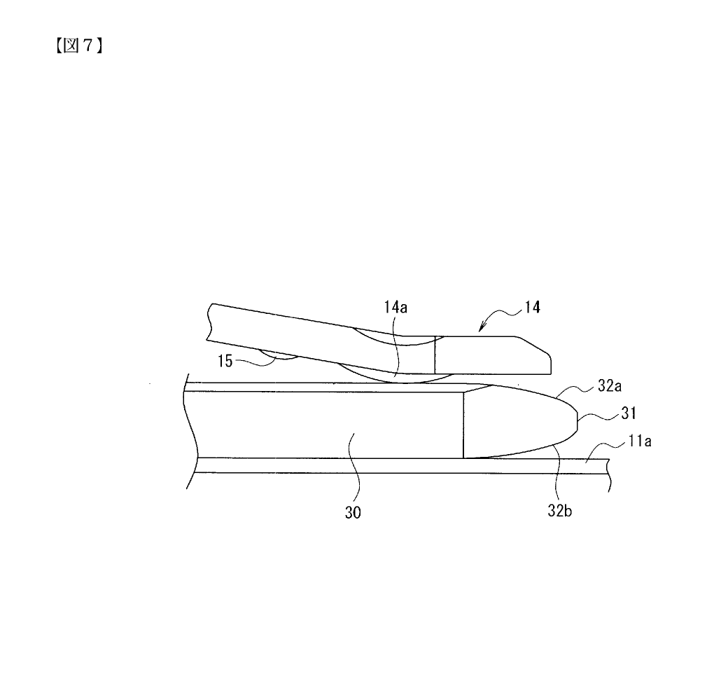

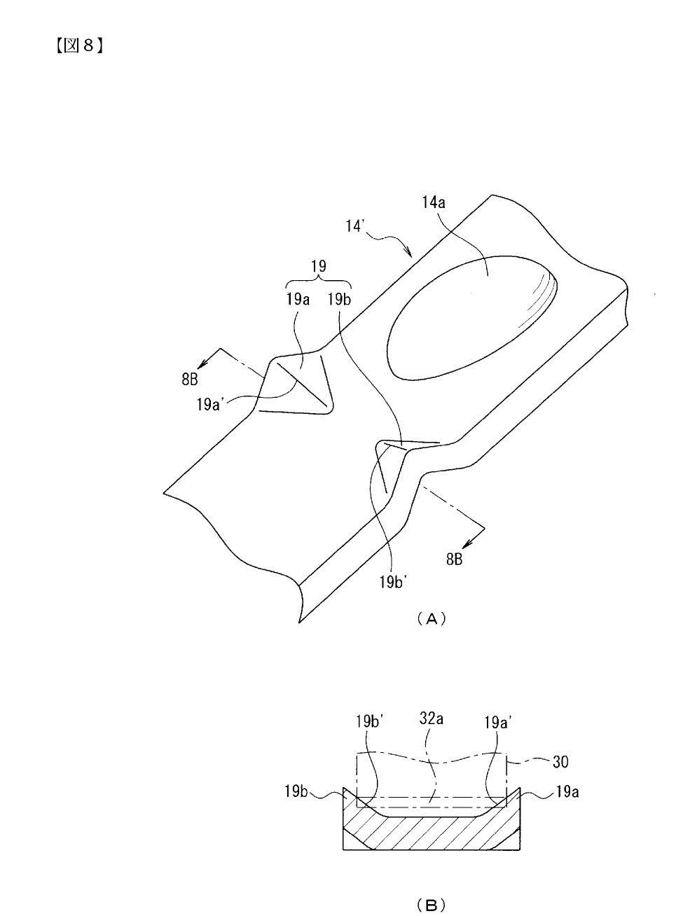

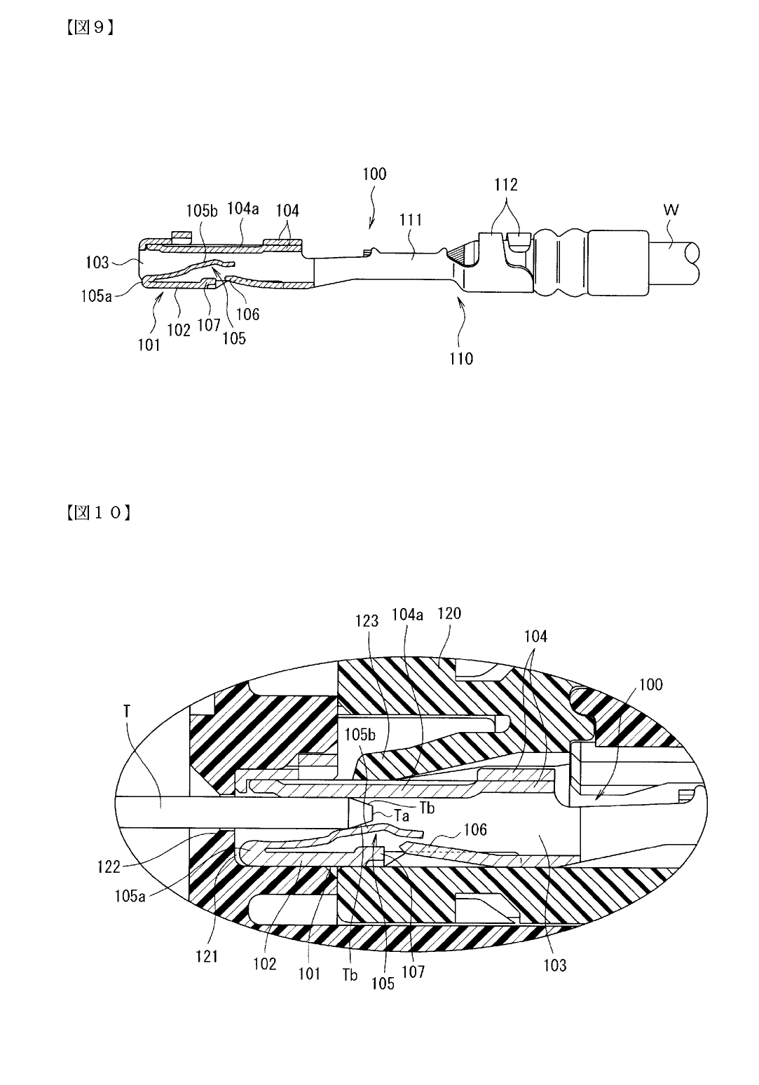

Next, a second embodiment of the female contact of the present invention will be described with reference to FIGS. 8A and 8B. The resilient contact member 14′ of the female contact shown in FIGS. 8A and 8B has the same basic construction as the resilient contact member 14 of the female contact 1 shown in FIGS. 1 through 3, but the difference is in the shape of the projection that causes upward displacement of the contact section 14a from the initial position before the tip end surface 31 of the male contact 30 contacts the contact section 14a. Specifically, the projection 19 is constructed from a pair of projecting parts 19a and 19b provided on either end portion of the resilient contact member 14′ and respectively having ridge lines 19a′ and 19b′ that are angled inward in the direction of width as seen in cross-section as shown in FIG. 8B. The pair of projecting parts 19a and 19b are provided on either end portion of the resilient contact member 14′ further toward the front than the contact section 14a.

Thus, the projection 19 is constructed from a pair of projecting parts 19a and 19b provided on either end portion of the resilient contact member 14′ and respectively having ridge lines 19a′ and 19b′ that are angled inward in the direction of width as seen in cross-section. Therefore, the projection 19 can be formed easily by forming the corner edges at both end portions of the resilient contact member 14′.

When the male contact 30 is inserted into the receptacle 10 of the female contact shown in FIGS. 8A and 8B, the ridge lines 19a′ and 19b′ of the pair of projecting parts 19a and 19b constituting the projection 19 climb over the upper angled surface 32a as shown in FIG. 8B before the tip end surface 31 of the male contact 30 contacts the contact section 14a. As a result, the resilient contact member 14′ and contact section 14a are displaced upward from the initial positions. Consequently, as in the case with the female contact 1 shown in FIGS. 1 through 3, the impact of the tip end surface 31 of the male contact 30 with the contact section 14a is reliably avoided. As a result, the contact surface of the contact section 14a is not scratched, and the plated surface applied on the contact surface does not become rough, minimizing failure in the electrical connection between the male contact 30 and the resilient contact member 14′ of the female contact caused by an increase in the contact resistance.

Embodiments of the present invention have been described above. However, the present invention is not limited to these embodiments, and various alterations and modifications can be made.

For example, the male contact 30 is not limited to a contact formed in a tab shape, and any other male contact such as a pin may also be used.

Furthermore, the projection 15 or 19 is provided further toward the front than the contact section 14a in the direction of insertion of the male contact 30; however, as long as the contact section 14a and the upper angled surface 32a come into contact at a shallow angle close to 180°, it is not absolutely necessary to dispose such a projection toward the front in the direction of insertion of the male contact 30.

Although projections 15 and 19 are formed as shown, as long as the projection is something that can cause displacement of the contact section 14a from the initial position before the tip end surface 31 of the male contact 30 contacts the contact section 14a, the projection is not limited to these shapes.

In addition, it would also be possible to construct the projection 15 or 19 so that the contact section 14a is caused to be displaced downward from the initial position (the position of the contact section 14a when the resilient contact member 14 is in a free state) before the tip end surface 31 of the male contact 30 contacts the contact section 14a.

What is claimed is:

1. A female contact comprising a resilient contact member having a contact section that contacts a mating male contact, the resilient contact member having a projection which causes the contact section to be displaced from an initial position before a tip end surface of the male contact comes into contact with the contact section upon insertion.

2. The female contact according to claim 1 wherein the height of the projection is set so that the projection does not contact the male contact when the male contact has been completely inserted and has made contact with the contact section.

3. The female contact according to claim 2 wherein the projection is constructed by forming a central portion of the resilient contact member.

4. The female contact according to claim 3, wherein the projection is constructed from a pair of projecting parts provided on either end portion of the resilient contact member in the direction of width.

5. The female contact according to claim 4 wherein the projecting parts respectively have ridge lines that are angled inward along a width thereof.

6. The female contact of claim 3 further comprising a resilient support member extending from a top plate downwardly and forwardly to contact and support a rear end of the resilient contact member as it flexes to receive the male contact.
